(19) United States
(12) Patent Application Publication
(10) Pub. No.: US 2021/0205846 A1
(43) Pub. Date: Jul. 8, 2021

(54) HYDRAULIC COMPACTION GENERATING DEVICE

(71) Applicant: Albert Ben Currey, Phoenix, AZ (US)

(72) Inventor: Albert Ben Currey, Phoenix, AZ (US)

(21) Appl. No.: 17/207,047

(22) Filed: Mar. 19, 2021

Related U.S. Application Data
(63) Continuation-in-part of application No. 16/802,851, filed on Feb. 27, 2020, now Pat. No. 10,987,698.
Application No. 16/802,851 is a continuation of application No. 16/553,088, filed on Aug. 27, 2019, now Pat. No. 10,610,896.

(51) Int. Cl. B06B 1/18

(52) U.S. Cl. CPC B06B 1/186

(57) ABSTRACT

A hydraulic compaction generation device is provided. The device includes a manifold member having first and second inner volumes, first and second fluid inlet orifices and first and second fluid outlet orifices. The device further includes first and second compaction generating members, each having a grooved drive and an off-center weight. The first and second inner volumes receive the first and second compaction generating members within the first and second inner volumes respectively. The retaining plate retain the first and second compaction generating members within the first and second inner volumes in response to coupling the retaining plate to the manifold member. The first and second compaction generating members rotate and generate forcible up and down movements in response to hydraulic fluid flowing into the manifold member through the first and second inlet orifices and out of the manifold member through the first and second outlet orifices.

### CROSS REFERENCE TO RELATED APPLICATION[S]

This application is a continuation-in-part of the earlier U.S. Utility Patent application Ser. No. 16/802,851, filed Feb. 27, 2020, now pending, which is a continuation of the earlier U.S. Utility patent application Ser. No. 16/553,088, filed Aug. 27, 2019, now U.S. Pat. No. 10,610,896, the disclosures of which are hereby incorporated entirely herein by reference.

### BACKGROUND OF THE INVENTION

### Technical Field

This invention relates generally to compaction generating device, and more particularly to a hydraulic driven compaction generating device that can be very small or very large, under high pressure hydraulics within a pressure range of 0-6000 psi, which is not available today.

### State of the Art

Plate compactors are designed to compact lose material, such as soil, gravel, small aggregate, asphalt and so forth. Conventional plate compactors include a heavy plate on the bottom of the machine that moves up and down quickly. The combination of rapid impacts, plate weight and impact forces the soil underneath to compact or pack together more tightly. These plate compactors can be powered by gas engines or by hydraulic motors. Plate compactors that operate with hydraulic fluid are typically used with excavators or back hoes as an attachment. However, these hydraulic plate compactors are limited in they have cyclic up and down motions wherein the amplitude of the up and down motion and the weight of the plate combine for the compaction, wherein the plate is moved in a circular type motion up and down and includes losses of force due such motion and not an up down motion.

Therefore, there is a need for an improved compaction generating device that can be coupled to a plate or the like to generate up and down forces.

### SUMMARY OF THE INVENTION

An embodiment includes a hydraulic compaction generation device comprising: a manifold member comprising a first inner volume, a second inner volume, a first fluid inlet orifice, a second inlet orifice, a first fluid outlet orifice and a second fluid outlet orifice; a first compaction generating member and a second compaction generating member, each comprising a shaft having a grooved drive and an off-center weight, wherein: each compaction generating member is a cylindrical shaft; and each grooved drive comprising a plurality of triangular recessed grooves formed in an outer surface of the shaft around a circumference of the shaft, wherein each triangular recessed groove of the plurality of triangular recessed grooves are evenly spaced around the circumference of the shaft; and at least one retaining plate, wherein: the first inner volume receives the first compaction generating member within the first inner volume; the second inner volume receives the second compaction generating member within the second inner volume; the at least one retaining plate retains the first compaction generating member and the sconed compaction generating member within the first inner volume and the second inner volume respectively in response to coupling the at least one retaining plate to the manifold member; and the first and second compaction generating members rotate simultaneously in opposite directions and generate forceable up and down movements while reducing horizontal forceable movement in response to hydraulic oil flowing into the first inner volume and the second inner volume of the manifold member through the first inlet orifice and the second inlet orifice, wherein a portion of the hydraulic oil entering through the first inlet orifice engages the plurality of triangular recessed grooves to rotate the first compaction generating member and a portion of the hydraulic oil entering through the second inlet orifice engages the plurality of triangular recessed grooves to rotate the second compaction generating member, and the hydraulic oil flows out of the first inner volume and the second inner volume of the manifold member through the first outlet orifice and the second outlet orifice respectively.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a hydraulic compaction generating device according to an embodiment;

FIG. 2 is another perspective view of a hydraulic compaction generating device showing timing gears according to an embodiment;

FIG. 3 is a perspective view of a manifold member of a hydraulic compaction generating device according to an embodiment;

FIG. 4 is a side view of a manifold member of a hydraulic compaction generating device according to an embodiment;

FIG. 5 is a perspective view of a manifold member of a hydraulic compaction generating device according to an embodiment;

FIG. 6 is a side section view of a manifold member of a hydraulic compaction generating device according to an embodiment;

FIG. 7A is side section view of a manifold member with first and second compaction generating members of a hydraulic compaction generating device according to an embodiment;

FIG. 7B is a close-up partial view of a manifold member with first and second compaction generating members of a hydraulic compaction generating device according to an embodiment;

FIG. 8A is a perspective view of an alternative compaction generating member of a hydraulic compaction generating device according to an embodiment;

FIG. 8B is a perspective view of an compaction generating member of a hydraulic compaction generating device according to an embodiment;

FIG. 8C is an end view of an compaction generating member of a hydraulic compaction generating device according to an embodiment;

FIG. 8D is a side view of an compaction generating member of a hydraulic compaction generating device according to an embodiment;

FIG. 9A is a section view of the first and second compaction generating members of a hydraulic compaction generating device rotating in opposite directions according to an embodiment;

FIG. 9B is a section view of the first and second compaction generating members of a hydraulic compaction generating device rotating in opposite directions according to an embodiment; and

FIG. 10 is a side view of a hydraulic compaction generating device forcibly moving in up and down directions according to an embodiment.

### DETAILED DESCRIPTION OF EMBODIMENTS OF THE INVENTION

As discussed above, embodiments of the present invention relate to a hydraulic driven compaction generating device.

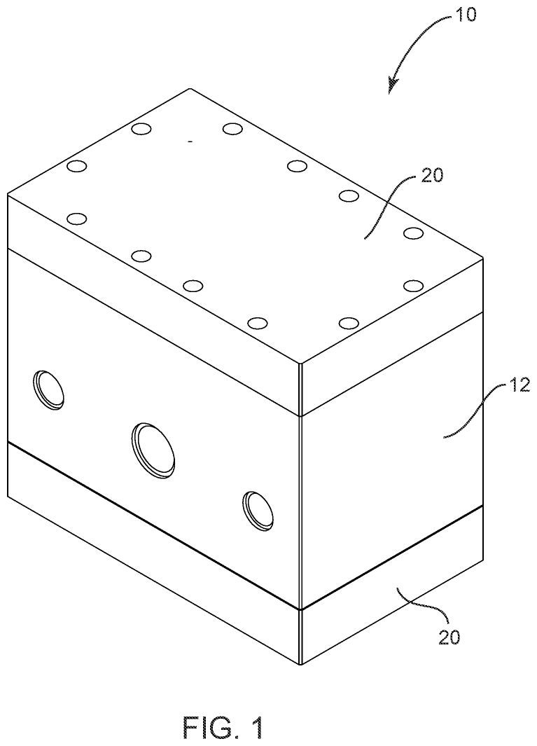

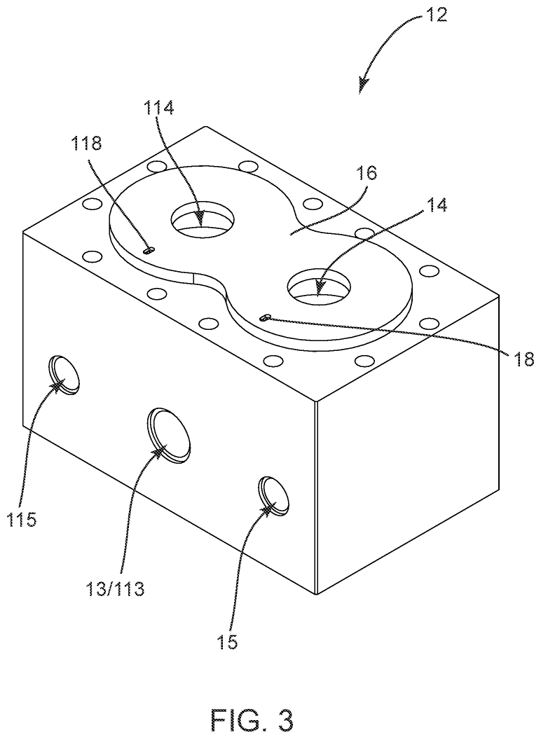

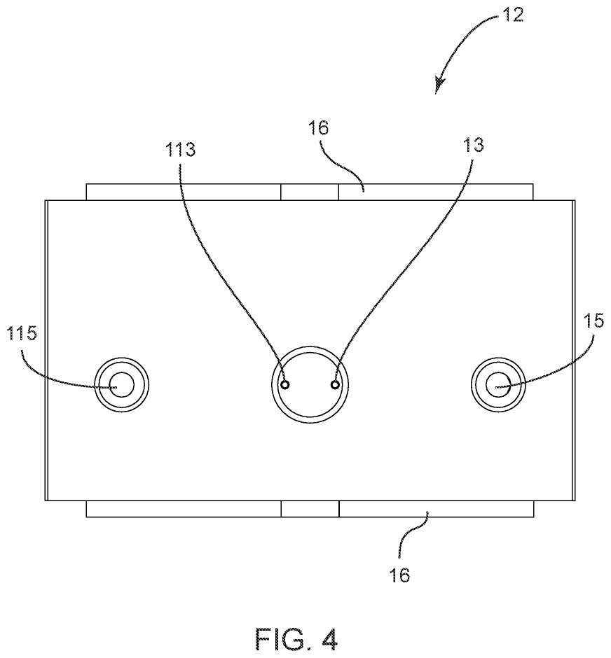

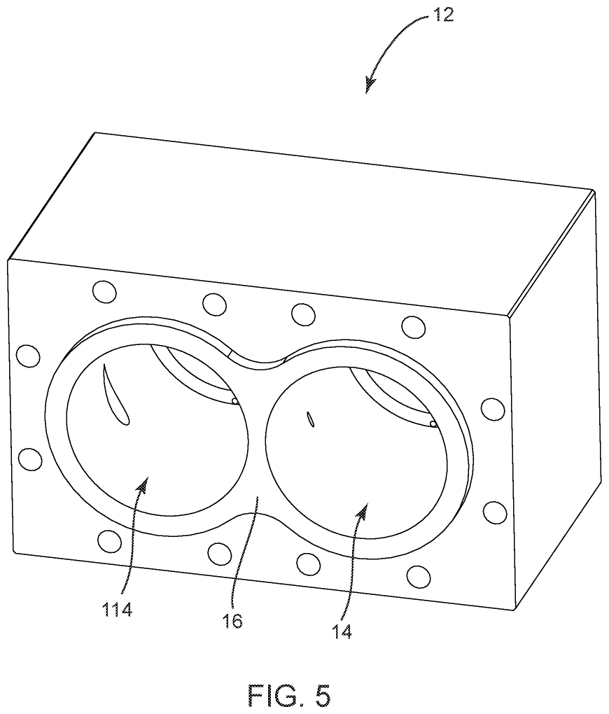

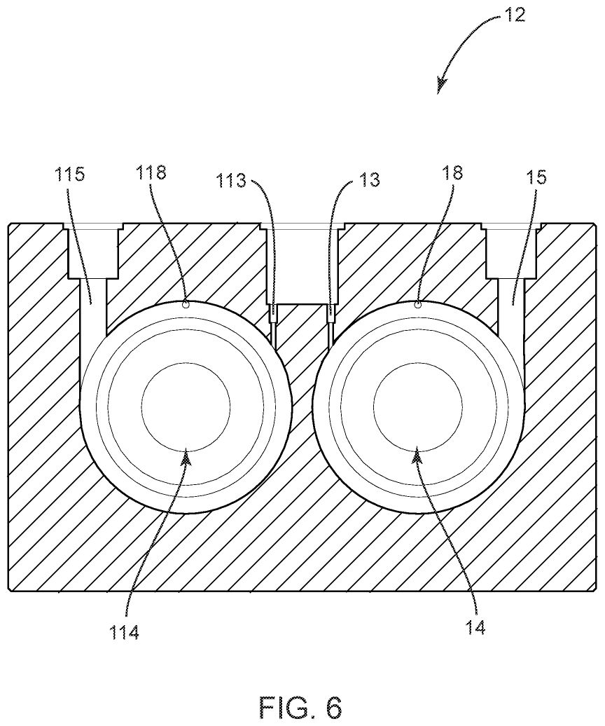

Referring to the drawings, FIGS. 1-10 depict an embodiment of a hydraulic driven compaction generating device 10. The device 10 generally comprises a manifold member 12, retaining plates 20, a first compaction generating member 30, and a second compaction generating member 130, wherein the first compaction generating member 30 and the second compaction generating member 130 are retained within the manifold member 12 by coupling the retaining plates 20 to the manifold member 12.

The manifold member 12 may be a block shape or other shape that is needed for the operation of the compaction generating device 10. The manifold member 12 may comprise a first inner volume 14 and a second inner volume 114, wherein each may be an aperture extending through the manifold member 12. The first inner volume 14 and the second inner volume 114 may be bounded on each end by coupling the retaining plates 20 on opposing side of the manifold member 12. In embodiments, the first inner volume 14 and the second inner volume 114 are cylindrical in shape. The manifold member 12 may also comprise a first inlet orifice 13 and a first outlet orifice 15. This allows hydraulic fluid to flow into the manifold member 12 through the first inlet orifice 13 and into the first inner volume 14 to engage and rotate the first compaction generating member 30, and then out through the first outlet orifice 15. The first outlet orifice 15 may have a larger opening to the first inner volume 14 than the first inlet orifice 13 in order to remove fluid from the first inner volume 14 as quickly as possible. The manifold member 12 may also comprise a second inlet orifice 113 and a second outlet orifice 115. This allows hydraulic fluid to flow into the manifold member 12 through the second inlet orifice 113 and into the second inner volume 114 to engage and rotate the second compaction generating member 130, and then out through the second outlet orifice 115. The second outlet orifice 115 may have a larger opening to the second inner volume 114 than the second inlet orifice 113 in order to remove fluid from the second inner volume 114 as quickly as possible. The manifold 12 may include an inlet port 70 that an inlet hose adapter (not shown) may be coupled to, wherein the inlet port 70 directs hydraulic oil to both the first and the second inlet orifices 13, 113 simultaneously. The manifold 12 may include first and second outlet ports 72, 74 that outlet hose adapters (not shown) may be coupled between the first and second outlet orifices 15, 115 respectively and an outlet hose coupled to each outlet hose adapter, thereby allowing a fluid inlet hose and two fluid outlet hoses to be coupled to the manifold member 12 for operation of the device 10. The first and second inlet orifices 13, 113 and the first and second outlet orifices 15, 115 may be at any angle through the manifold member 12 to accomplish the flow of hydraulic fluid into and out of the manifold member 12. As will be understood hydraulic fluid may comprise, but is not limited to, gas, air, oil, water and the like fluids that can be flowed through the system and operate the compaction generating device 10.

In further embodiments, the first and second inlet orifices 13, 113 may each comprise a reduce diameter portion extends between the inlet orifice 13 the inner volume 14 of the manifold member 12. This reduction of diameter may operate to increase the pressure of the hydraulic fluid engaging the compaction generating member 30.

The manifold member 12 comprises a protrusion 16 extending from each side and adjacent to the aperture forming a portion of the inner volume 14. The protrusion 16 may operate to extend within a recess of the retaining plate 20 when the retaining plate 20 is coupled to the manifold member 12.

The manifold member 12 may have various apertures and recesses that are utilized to couple the retaining plate 20 to the manifold member and for use of couplers to couple the manifold member 12 to an external device to vibrate. While these apertures and recesses are shown, they are only for exemplary purposes and should not be considered a limitation, but simply as one way that certain components of a hydraulic compaction generating device 10 may be coupled together. Other forms of coupling components together are contemplated and may be used with departing from the scope of the invention and claims. Further, the manifold member 12 is depicted as a unitary body member. It will be understood that the manifold member 12 may comprise at least two portions that may be coupled together to form the manifold member 12.

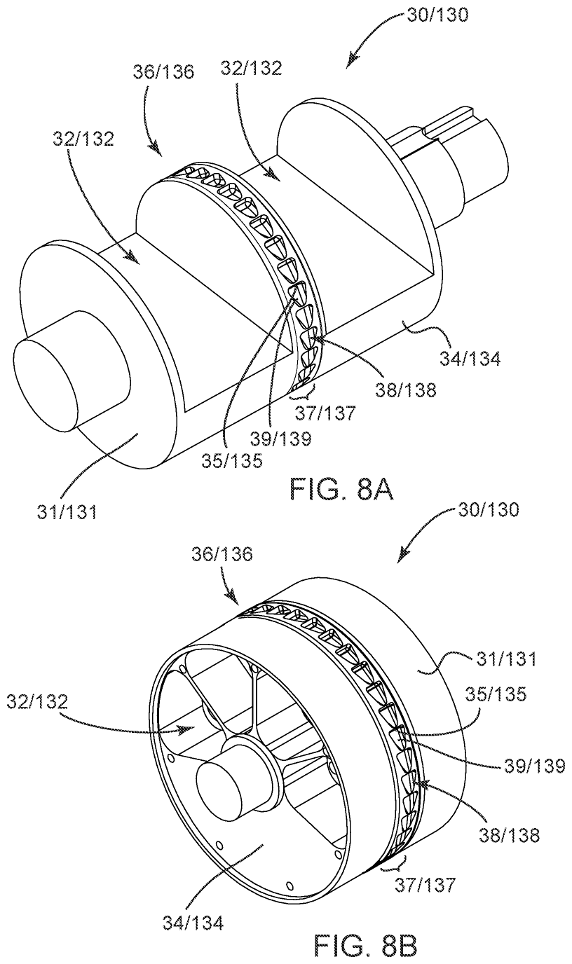

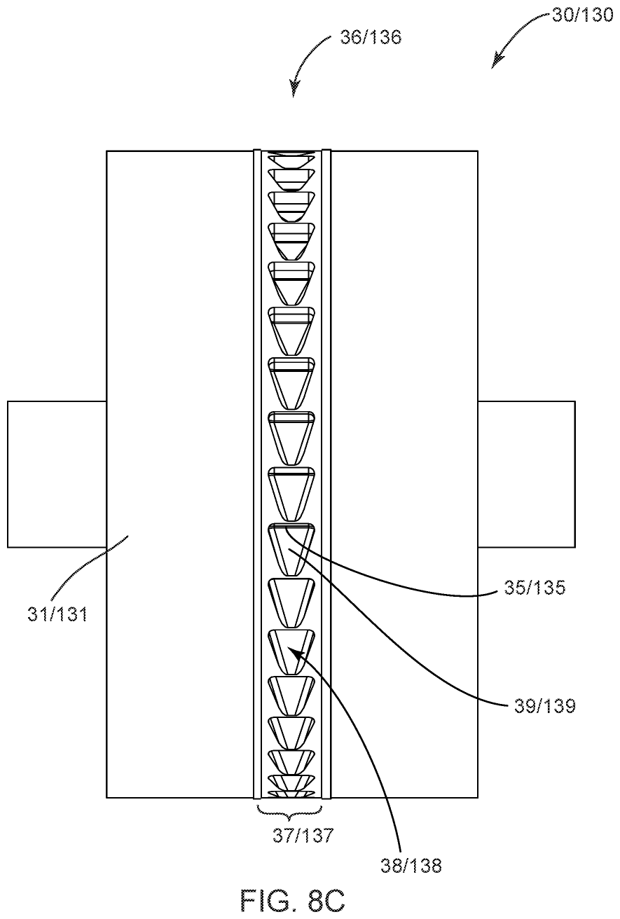

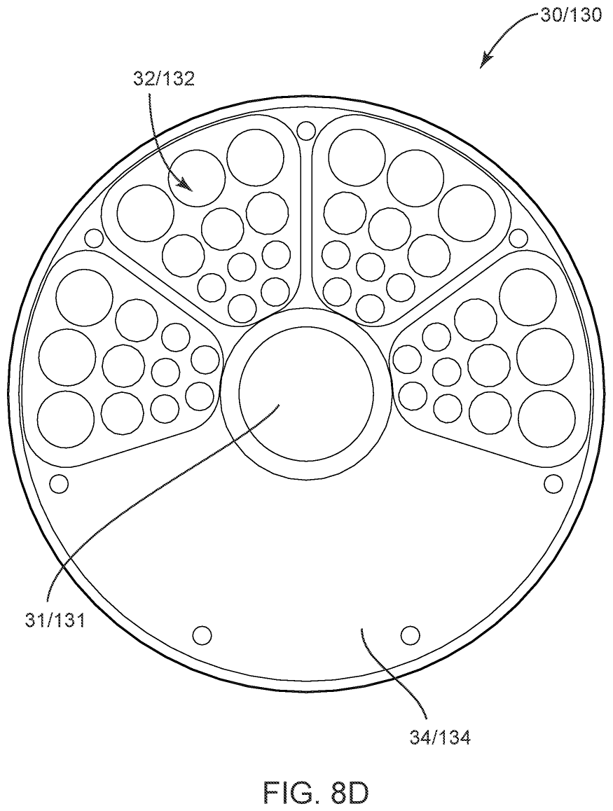

Referring to FIGS. 8A-8D, The first and second compaction generating members 30, 130 may each comprise a shaft 31, 131 having voids 32, 132 formed or cut into a portion or portions of the shaft 31, 131. The voids 32, 132 reduce weight on one side of the shaft 31, 131 thereby creating a weighted side 34, 134 of the shaft, wherein the center of gravity is offset from the axis and is located toward the weighted side of the shaft 31, 131 and not on the axis of the shaft 31, 131, thereby making the weight “off-center”. The shafts 31, 131 of the first and second compaction generating members 30, 130 are rotatable within the first and second inner volumes 14, 114 respectively of the manifold member 12. The rotation of the shafts 31, 131 with the off-center weight or offset center of gravity results in compaction up and down movement of the manifold member 12. As shown in FIG. 8A, the voids 32, 132 may comprise channels formed in the shaft 31, 131 or, as shown in FIGS. 8B and 8D, may comprise recesses formed in ends of the shaft 31, 131 or any other void formed to offset the center of gravity to form and off-center weight.

The first and second compaction generating member 30, 130 each comprises a channel grooved drive 36, 136 formed in the outer surface of the shaft 31, 131 around a circumference of the shaft 31, 131. The channel grooved drive 36, 136 comprises a channel 37, 137 formed in the outer surface of the shaft 31, 131 and around a circumference of the shaft 31, 131. A plurality of grooves 38, 138 are formed in the outer surface of the shaft 31, 131 around a circumference of the shaft 31, 131. The plurality of grooves 38, 138 are evenly spaced around the circumference of the shaft 31, 131, such that hydraulic fluid may engage the grooves 38, 138 to rotate the shaft 31, 131. The grooves 38, 138 are shown as triangular shaped recesses formed in the shaft 31, 131 having fluid engaging surfaces 35, 135 extending into the of the shaft 31, 131 and a tapered surface 39, 139 extending from an end of fluid engaging surface and tapered up to reach the outer surface of the shaft 31, 131.

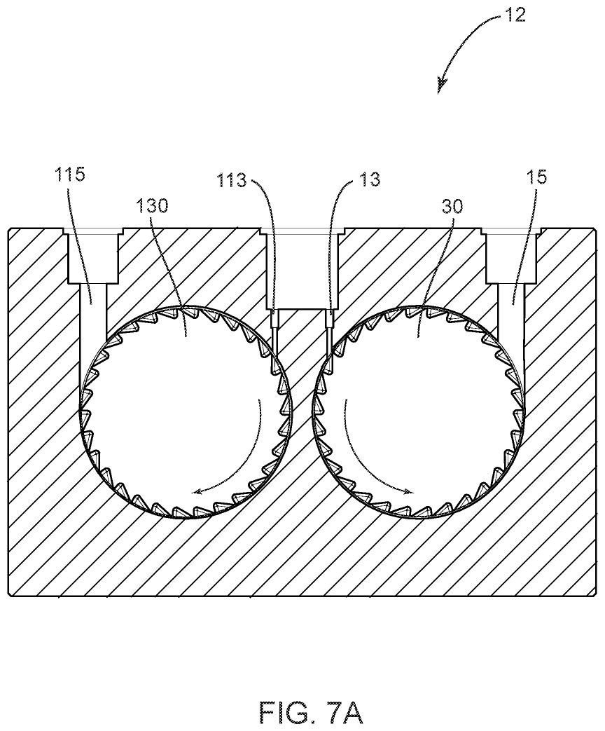

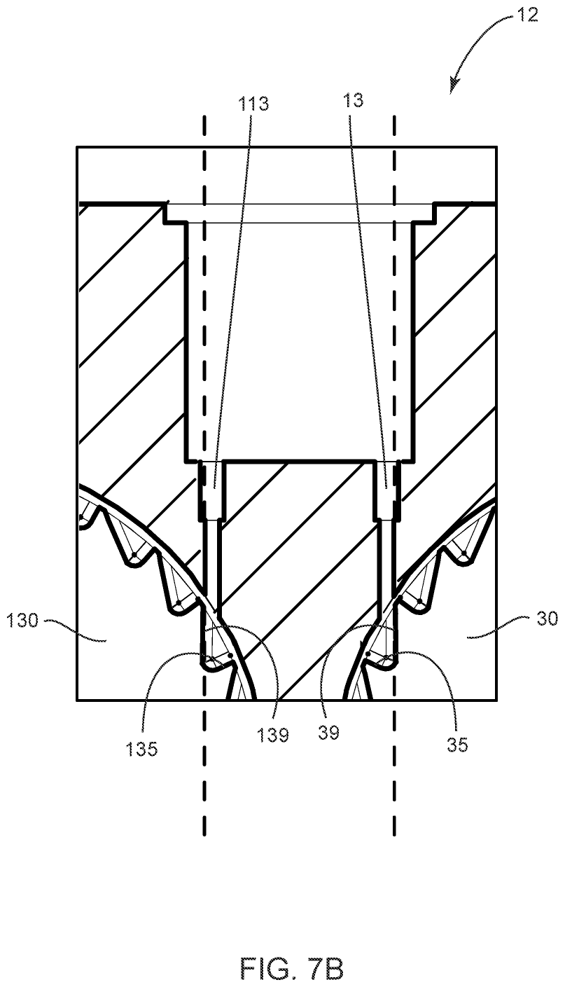

As shown in FIGS. 7A and 7B, the plurality of grooves 38, 138 operate to rotate the compaction generating member 30, 130 as fluid flowing from the first and second inlet orifices 13, 113 of the manifold member 12, the fluid applies force to the fluid engaging surfaces 35, 135 causing a partial rotation and extends an adjacent fluid engaging surface 35, 135 within the stream of hydraulic fluid entering through the first or second inlet orifice 13, 113 to continuously rotate the shaft 31, 131 during flow of hydraulic fluid into the manifold member 12. The triangular shape of the grooves 38, 138 operate for allow the fluid stream to engage the fluid engaging surface 35, 135 for a longer period of time or through a longer arc to more efficiently rotate the shaft 31, 131. To further assist in increasing the amount of the fluid engaging surface 35, 135 that the fluid stream engages, the inlet orifice 13, 113 has an edge aligned with the tapered surface 39, 139 of each groove 38, 138 for a moment as each groove 38, 138 rotates past the inlet orifice 38, 138, thereby allowing the fluid stream to contact the fluid engaging surface 35, 135 from one end to the other as the shaft 31, 131 rotates within the manifold.

Additionally, when utilizing the first and second compaction generating members 30, 130, the outer surface of the shaft 31, 131 may be manufactured to have a mirror finish. Additionally, the first and second inner volumes 14, 114 of the manifold member 12 may also be manufactured to have a mirror finish. Mirror finish of these components may be accomplished through polishing of the surfaces. The mirror finish of each reduces the friction between the outer surface of the shaft 31, 131 rotating within the first and second inner volumes 14, 114 and allows the compaction generating member 130 to rotate more freely and more readily than shafts without the mirror finish. It additionally, causes less wear to these components than those that do not have a mirror finish.

Further, as shown in FIG. 7B, in some embodiments, the shaft 31, 131 may include a protrusion surface 39, 139 that extends from the outer surface of the shaft 31, 131 around a circumference of the shaft 31, 131. The channel grooved drive 36, 136 would then be formed in the protrusion surface 39, 139, as shown in FIG. 8C. The raised protrusion surface 39, 139 allows the shaft 31, 131 to rotate with less friction.

Each retaining plate 20 may comprise a recess for receiving a protrusion 16 of the manifold member 12 and for receiving and retaining the bearings (not shown). In some embodiments, the recess may be a countersunk recess having the same shape as the protrusion 16, wherein there is a lip or step for engaging the protrusion 16. Additionally, the retaining plate 20 may comprise a channel surrounding the recess, wherein the channel operates to receive a sealing member, wherein the sealing member is retained within the channel when the retaining plate 30 is coupled to the manifold member 12. The sealing member may be formed of deformable material, such as, but not limited to rubber, wherein the sealing member may be compressed between the retaining plate 20 and the manifold member 12 within the channel when the retaining plate 20 is coupled to the manifold member 12 by use of bolts or the like. This operates to inhibit the leaking of hydraulic fluid from within the manifold member 12.

The manifold member 12 may further include a first weep hole 18 and a second weep hole 118 in a side of the manifold that extends from the first inner volume 14 and the second inner volume 114 respectively, allowing hydraulic oil to exit to relieve pressure within the first and second inner volumes 14, 114. The oil that exits the weep holes 18, 118 operate to lubricate first and second timing gears 80, 180.

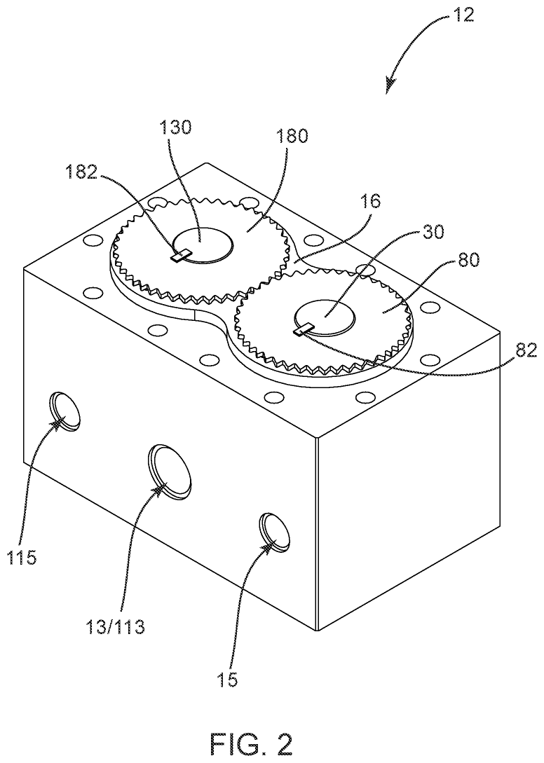

Referring to FIGS. 2, 7 and 9A-10, operation of the hydraulic compaction generating device 10 is depicted. The first and second compaction generating members 30, 130 are coupled within the manifold member 12 by inserting first and second compaction generating members 30, 130 within the first and second inner volumes 14, 114 respectively of the manifold member 12. Bearings may be coupled to each end of the first and second compaction generating members 30, 130. One end of each of the first and second compaction generating members 30, 130 extend through a surface of the manifold member 12. First and second timing weeps 80, 180 are coupled to the end of the first and second compaction generating members 30, 130, such as by use of a press fit coupling member 82, 182. The timing gears 80, 180 include teeth that engage each other and ensure that the first and second compaction generating members 30, 130 rotate in opposite directions simultaneously and at the same rate and timing. The retaining plates 20 are coupled to the manifold member 12 to retain the compaction generating members 30, 130 the bearings, and the timing gears 80, 180 within the manifold member 12. The first channel grooved drive 36 is aligned with the first inlet orifice 13 and the second channel grooved drive 136 is aligned with the second inlet orifice 113 of the manifold member 12.

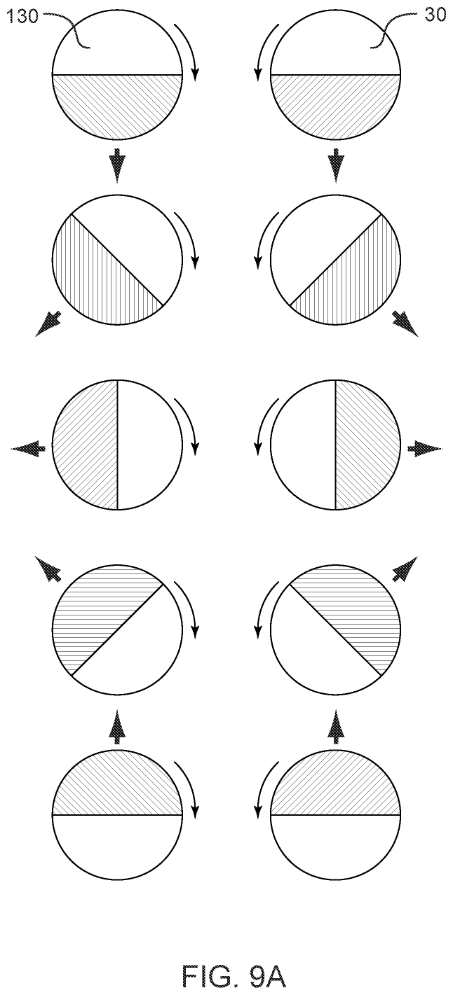

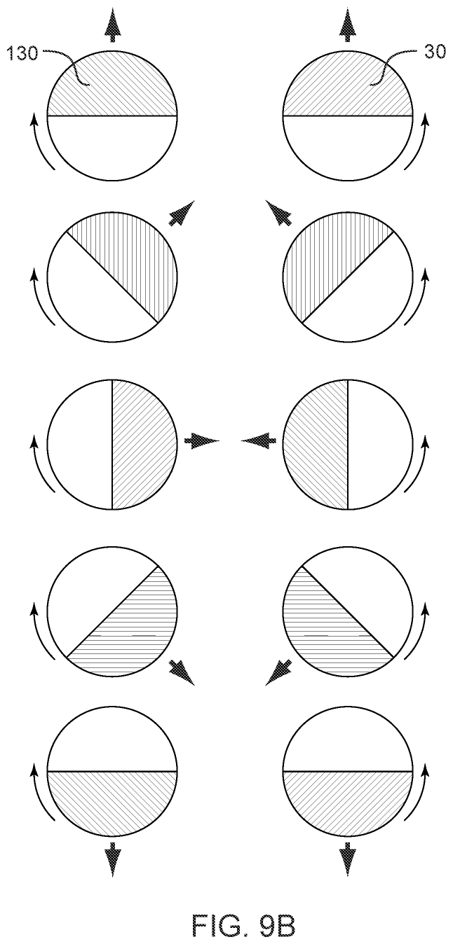

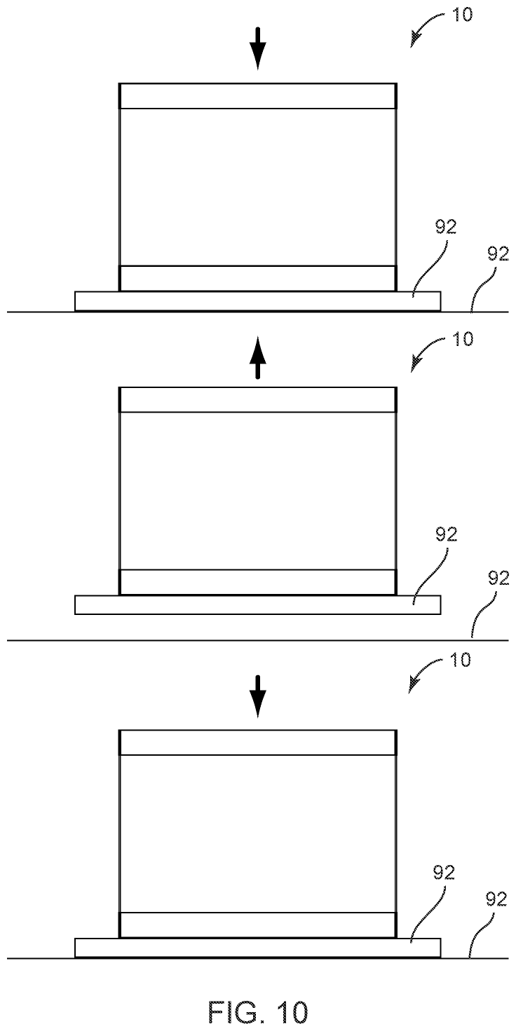

Hydraulic fluid is pumped into the first and second inlet orifices 13, 113 of the manifold member 12 simultaneously under the same pressure through a single inlet hose and engages the channel grooved drives 36, 136 to rotate the first and second compaction generating members 30, 130 respectively (see FIG. 7A). The off-center weight of the first and second compaction generating members 30, 130 results in up and down force movement of the device 10 as depicted in the FIG. 10. Referring to FIGS. 9A and 9B, this is caused by a throw action of the simultaneous rotation of the off-center weight of the first and second compaction generating members 30, 130, resulting from both the same pressure engaging the first and second channel grooved drives 36, 136 and the operation of the first and second timing gears 80, 180. The first and second compaction generating members 30, 130 rotate in opposite directions, as depicted, resulting in throws, as depicted by vector arrows, that cancel horizontal forces of the device 10 through the entire rotation of the first and second compaction generating members 30, 130, while combining the vertical forces caused by the throws of the off-center weight of in the same up and down direction based on the location of the off-center weight during rotation of the first and second compaction generating members 30, 130. This allows for the up and down force to be a linear movement as shown in FIG. 10 to lift a plate 90 or other external device coupled to the compaction generating device 10 up and down to apply force to a surface 92.

The hydraulic fluid pumped into the manifold member 12 may have a dual function. The first function is to rotate the first and second compaction generating members 30, 130. The second function is to provide lubrication of the first and second compaction generating members 30, 130 as each rotates within the manifold member 12. Additionally, since the retaining plate 20 seals the hydraulic fluid within the manifold member 12, the flow of fluid through the first and second inlet orifices 13, 113 and out the first and second outlet orifices 15, 115 operates to flush the system and maintain the lubrication, requiring little to no maintenance by eliminating contaminates from entering and remaining in the manifold member 12. Additionally, with little to no load on the compaction generating member 30, friction is reduced because it is simply the rotation of the compaction generating member 30.

The hydraulic compaction generating device 10 is capable of operating at high pressures. For instance, the hydraulic compaction generating device 10 may operate in a fluid pressure range of 0-6000 psi.

The device 10 may be coupled to external devices in order to supply the desired up and down force compaction effect on the external device. The device 10 may also be scaled to various sizes as needed for the various desired compaction and implementation of the compaction generating device 10.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A hydraulic compaction generation device comprising:
a manifold member comprising a first inner volume, a second inner volume, a first fluid inlet orifice, a second inlet orifice, a first fluid outlet orifice and a second fluid outlet orifice;
a first compaction generating member and a second compaction generating member, each compaction generating member comprising a shaft having a channel grooved drive and an off-center weight, wherein:
each compaction generating member is a cylindrical shaft; and
each channel grooved drive comprises a channel formed in an outer surface of the shaft around a circumference of the shaft, and a plurality of triangular recessed grooves formed in an outer surface of the shaft around a circumference of the shaft, wherein each triangular recessed groove of the plurality of triangular recessed grooves are evenly spaced around the circumference of the shaft; and
at least one retaining plate, wherein:
the first inner volume receives the first compaction generating member within the first inner volume;
the second inner volume receives the second compaction generating member within the second inner volume;
the at least one retaining plate retains the first compaction generating member and the sconed compaction generating member within the first inner volume and the second inner volume respectively in response to coupling the at least one retaining plate to the manifold member; and
the first and second compaction generating members rotate simultaneously in opposite directions and generate forceable up and down movements while reducing horizontal forceable movement in response to hydraulic oil flowing into the first inner volume and the second inner volume of the manifold member through the first inlet orifice and the second inlet orifice, wherein a portion of the hydraulic oil entering through the first inlet orifice engages the plurality of triangular recessed grooves to rotate the first compaction generating member and a portion of the hydraulic oil entering through the second inlet orifice engages the plurality of triangular recessed grooves to rotate the second compaction generating member, and the hydraulic oil flows out of the first inner volume and the second inner volume of the manifold member through the first outlet orifice and the second outlet orifice respectively.

2. The device of claim 1, wherein the first and second compaction generating members each comprise at least one void formed into the shaft to create the off-center weight shaft.

3. The device of claim 1, wherein the manifold member is formed as a unitary member.

4. The device of claim 1, further comprising a sealing member coupled between the at least one retaining plate and the manifold member.

5. The device of claim 1, wherein the manifold member is configured to couple to an external device for moving the external device with force in up and down reciprocating directions.

6. The device of claim 1, further comprising a first timing gear coupled to the first compaction generating member and a second timing gear coupled to the second compaction generating member.

7. The device of claim 7, wherein the first and second timing gears assist in keeping the opposite rotation of the first and second compaction generating members at the same rate and timing.
